(19) United States
(12) Patent Application Publication
(10) Pub. No.: US 2020/0146923 A1
(43) Pub. Date: May 14, 2020

(54) ARM SUPPORT SYSTEMS

(71) Applicant: ENHANCE TECHNOLOGIES, LLC, San Diego, CA (US)

(72) Inventor: Mark C. Doyle, Del Mar, CA (US)

(21) Appl. No.: 16/685,970

(22) Filed: Nov. 15, 2019

Related U.S. Application Data
(63) Continuation of application No. PCT/US2018/032846, filed on May 15, 2018.
(60) Provisional application No. 62/506,330, filed on May 15, 2017.

(51) Int. Cl. A61H 1/02; B25J 9/00

(52) U.S. Cl. CPC A61H 1/0281; B25J 9/0006; A61H 2201/149; A61H 2201/1638; A61H 2201/1652

(57) ABSTRACT

Systems and methods for supporting an arm of a user that include a harness configured to be worn by the user, an arm support coupled to the harness to support and follow movement of an arm of the user as the arm is raised and lowered; and compensation elements coupled to the arm support to apply an offset force to the arm support to at least partially offset a gravitational force acting on the arm as the arm is raised and lowered, the one or more compensation elements providing a force profile that varies the offset force based on an orientation of the arm support. The compensation elements may include a spring and a pivoting pulley coupled to the spring by a band, the pulley shaped to modify the offset force as the arm bracket is raised and lowered and the band causes the pulley to rotate.

### RELATED APPLICATION DATA

The present application is a continuation of International Application No. PCT/US2018/032846, filed May 15, 2018, which claims benefit of provisional application Ser. No. 62/506,330, filed May 15, 2017, the entire disclosures of which are expressly incorporated by reference herein.

### FIELD OF THE INVENTION

The present invention relates to systems, devices, and methods for supporting a user's arms, for example, to adaptive arm support systems that support one or both of a user's arms, while allowing substantially free motion, e.g., to allow the user to perform one or more tasks for extended periods of time with one or both arms extended.

### BACKGROUND

Numerous tasks require people to work with their arms outstretched, e.g., while operating hand tools or other equipment that they must at least partially support themselves. Examples include construction, surgery, dentistry, painting, dishwashing, and product assembly. Persons engaged in such activities may experience fatigue from prolonged muscular efforts required to resist the force of gravity on their arms in order to keep them extended. Weak or disabled persons may experience fatigue performing daily tasks. Static arm rests on chairs and work tables are only effective if the task is performed within a relatively restricted area, for example, at a computer keyboard. Tasks that involve a greater range of motion are not aided by static armrests.

Thus, there is a need for systems that may relieve fatigue experienced by persons performing tasks involving moderate to large ranges of motion and/or operating tools or other equipment.

### SUMMARY

The present invention is directed to systems, devices, and methods for supporting a user's arms, for example, to adaptive arm support systems or devices that support one or both of a user's arms, while allowing substantially free motion, e.g., to allow the user to perform one or more tasks for extended periods of time with one or both arms extended.

An arm support system can be used to provide a lift force to a user's arm to aid in the performance of tasks requiring the extension and raising of the arms. A spring-loaded arm support system is simple and does not require external power, but can have the unwanted side effect that spring force increases with displacement, making the spring force greatest at the lowest position of the arm (where lift is needed least). Modification of the lift force on a user's arm is desirable, for example, by increasing the force when the arm is raised (e.g., where the upper arm is raised above horizontal), and reducing the force when the arm is lowered (e.g., where the upper arm is lowered below horizontal until substantially vertical).

Various mechanisms for controlling the counterbalancing force that a spring-based arm support may apply to a user's arm have been previously disclosed. Exemplary arm support components that may be included in the embodiments herein, such as cassettes or other compensation elements, arm rest features, covers, and the like, are described in U.S. Publication Nos. 2012/0184880, 2014/0033391, 2014/0158839, and 2015/0316204, the entire disclosures of which are expressly incorporated by reference herein. These previous disclosures consider ways through which the force may be varied depending on the position of the user's arm, generally by geometrically changing the mechanical advantage provided to a resilient element (such as a spring), in effect “disadvantaging” it. Additional mechanisms and systems to achieve this are described herein.

In accordance with one embodiment, a system is provided for supporting an arm of a user that includes a harness configured to be worn on a body of a user; an arm support coupled to the harness configured to support an arm of the user, the arm support comprising an arm bracket including an arm rest for receiving an upper arm of a user, the arm bracket pivotable about a horizontal axis for following movement of the upper arm as the upper arm is raised and lowered; and one or more compensation elements coupled to the arm support to apply an offset force to the arm bracket to at least partially offset a gravitational force acting on the arm as the user raises and lowers the upper arm. In one embodiment, the one or more compensation elements may include a stationary member mounted on the arm support such that the stationary member remains stationary relative to the arm bracket as the arm bracket pivots about the horizontal axis; a pivoting pulley mounted on the arm bracket such that the pivoting pulley rotates about a pivot point fixed relative to the arm bracket; an elongate member comprising a first end coupled to the stationary member, a second end coupled to the pivoting pulley, and an intermediate portion wrapped partially around an outer surface of the pivoting pulley such that, as the arm bracket, pivots about the horizontal axis, the intermediate portion causes the pivoting pulley to rotate and further wrap and unwrap the intermediate region around the outer surface as the arm bracket is raised and lowered, respectively; and a resilient member coupled to the pivoting pulley to apply a potential force to the pivoting pulley, wherein the one or more compensation elements are configured such that a mechanical advantage is applied to the potential force as the upper arm is raised to increase the offset force applied to the arm bracket and a mechanical disadvantage is applied to the potential force as the upper arm is lowered to decrease the offset force applied to the arm bracket.

In accordance with another embodiment, a system is provided for supporting an arm of a user that includes a harness configured to be worn on a body of a user; an arm support coupled to the harness configured to support an arm of the user, the arm support comprising an arm bracket configured to support an upper arm of a user, the arm bracket pivotable about a horizontal axis for following movement of the upper arm as the upper arm is raised and lowered; and one or more compensation elements coupled to the arm support to apply an offset force to the arm bracket to at least partially offset a gravitational force acting on the arm as the user raises and lowers the upper arm.

In one embodiment, the one or more compensation elements include a stationary member mounted on the arm support such that the stationary member does not rotate when the arm bracket pivots about the horizontal axis; a pivoting pulley mounted on the arm bracket such that the pivoting pulley rotates about a pivot point on the arm bracket; an elongate member comprising a first end coupled to the stationary member, a second end coupled to the pivoting pulley, and an intermediate portion wrapped partially around an outer surface of the pivoting pulley such that, as the arm bracket pivots about the horizontal axis, the intermediate portion causes the pivoting pulley to rotate and further wrap and unwrap the intermediate region around the outer surface as the arm bracket is raised and lowered, respectively; and a resilient member coupled to the pivoting pulley to apply a potential force to the pivoting pulley. Optionally, the one or more compensation elements, e.g., the configuration of the stationary member and pivoting pulley, are configured such that a mechanical advantage is applied to the potential force as the upper arm is raised to increase the offset force applied to the arm bracket and a mechanical disadvantage is applied to the potential force as the upper arm is lowered to decrease the offset force applied to the arm bracket.

In another embodiment, the one or more compensation elements include a pivoting pulley mounted on the arm bracket such that the pivoting pulley rotates about a pivot point on the arm bracket; a resilient member comprising a resilient member first end fixed relative to the arm bracket and a resilient member second end; and an elongate band comprising a band first end fixedly coupled to the arm support, a band second end coupled to the resilient member second end, and an intermediate portion wrapped partially around an outer surface of the pivoting pulley such that, as the arm bracket pivots about the horizontal axis, the intermediate portion causes the pivoting pulley to rotate and applies tension to the resilient member to increase or decrease a potential force generated by the resilient member, wherein the one or more compensation elements are configured such that a mechanical advantage is applied to the potential force as the upper arm is raised to increase the offset force applied to the arm bracket and a mechanical disadvantage is applied to the potential force as the upper arm is lowered to decrease the offset force applied to the arm bracket.

In yet another embodiment, the one or more compensation elements include a stationary member mounted on the arm support such that the stationary member does not rotate when the arm bracket pivots about the horizontal axis; a pivoting pulley mounted on the arm bracket such that the pivoting pulley rotates about a pivot point on the arm bracket, the pivoting pulley and stationary member comprising engagement features that cooperate to cause the pivoting pulley to rotate and translate around an outer surface of the stationary member as the arm bracket pivots about the horizontal axis; and a resilient member comprising a first end fixed relative to the arm bracket and a second end coupled to the pivoting to apply a potential force to the pivoting pulley, wherein the one or more compensation elements are configured such that a mechanical advantage is applied to the potential force as the upper arm is raised to increase the offset force applied to the arm bracket and a mechanical disadvantage is applied to the potential force as the upper arm is lowered to decrease the offset force applied to the arm bracket.

In accordance with another embodiment, a method is provided for supporting an arm of a user during one or more tasks that includes placing a harness on the user, the harness comprising an arm support movable relative to the harness and including an arm rest; supporting a portion of the user's arm using the arm support such that the arm support subsequently follows movement of the user's arm; and performing one or more tasks involving movement of the user's arm, the arm support comprising one or more compensation elements that apply an offset force to at least partially offset a gravitational force acting on the arm as the user moves without substantially interfering in the movement, the one or more compensation elements providing a force profile that varies the offset force based on an orientation of the arm support.

Other aspects and features of the present invention will become apparent from consideration of the following description taken in conjunction with the accompanying drawings.

### BRIEF DESCRIPTION OF THE DRAWINGS

The present invention is best understood from the following detailed description when read in conjunction with the accompanying drawings. It will be appreciated that the exemplary devices shown in the drawings are not necessarily drawn to scale, with emphasis instead being placed on illustrating the various aspects and features of the illustrated embodiments.

FIG. 1 is a perspective view of a user wearing an exemplary embodiment of an arm support system that includes a harness and an arm support supporting an arm of the user.

FIGS. 2A and 3A are details of the arm support system of FIG. 1 with the user's arm raised and lowered, respectively.

FIGS. 2B and 3B are schematic diagrams of the arm support system of FIG. 1 showing the forces acting on the user's arm by the arm support system with the arm raised and lowered, respectively.

FIG. 4 is a perspective view of a user wearing another exemplary embodiment of an arm support system that includes a harness and an arm support supporting a right arm of the user.

FIGS. 5A and 6A are details of the arm support system of FIG. 4 with the user's arm raised and lowered, respectively.

FIGS. 5B and 6B are schematic diagrams of the arm support system of FIG. 4 showing the forces acting on the user's arm by the arm support system with the arm raised and lowered, respectively.

FIGS. 7A and 8A are side views of yet another embodiment of an arm support system worn by a user with the arm raised and lowered, respectively.

FIGS. 7B and 8B are schematic diagrams of the arm support system of FIGS. 7A and 8A, showing the forces acting on the user's arm by the arm support with the arm raised and lowered, respectively.

FIGS. 9A and 10A are side views of still another embodiment of an arm support system worn by a user with the arm raised and lowered, respectively.

FIGS. 9B and 10B are schematic diagrams of the arm support system of FIGS. 9A and 10A, showing the forces acting on the user's arm by the arm support with the arm raised and lowered, respectively.

### DESCRIPTION OF THE EXEMPLARY EMBODIMENTS

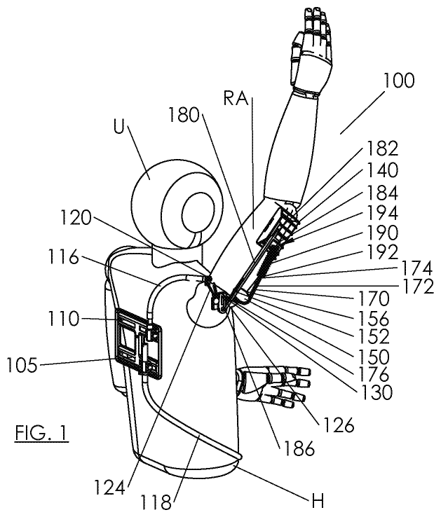

Turning to the drawings, FIGS. 1-3B show an exemplary embodiment of an arm support system 100, worn by a user U, that provides a counterbalancing force to the right arm RA of the user, e.g., similar to the systems described in the applications incorporated by reference herein. Generally, the system 100 includes a harness configured to be worn on a body of a user; an arm support coupled to the harness configured to support at least an upper arm of the user and pivot about one or more axes, and one or more compensation elements coupled to the arm support to apply an offset force to at least partially offset a gravitational force acting on the arm as the user moves.

The harness includes a frame 105 that provides a structure to transmit the weight of right arm RA to the user's abdomen A and/or hip H and one or more belts, pads, covers, and/or other features (not shown), similar to the systems described in the applications incorporated by reference herein. In the embodiment shown, the frame 105 includes a back structure 110, one or more shoulder tubes or supports 116 that extend at least partially over or around the user's shoulders, and one or more abdomen tubes or supports 118 that extend between the back structure 110 and a belt (not shown) that may be fastened around the user's hip H.

The shoulder tubes 116 may terminate at an upper end adjacent the user's shoulder at vertical axis pivot 120. The shoulder and abdomen supports 116, 118 are generally formed from rigid members such that the location of the vertical axis pivot 120 is fixed relative to the user's shoulder. However, the back structure 110 and/or the abdomen supports 118 may include hinges, pivots, or other components to accommodate the user rotating about the user's waist.

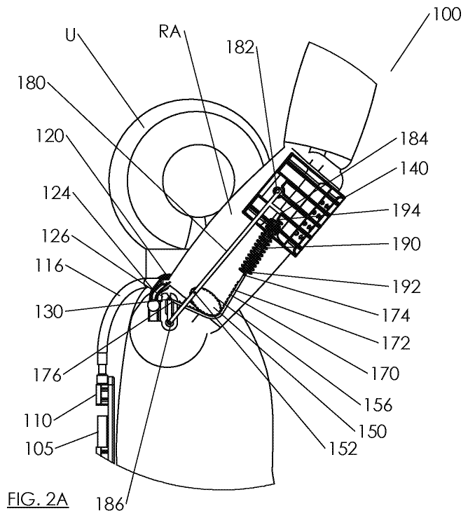

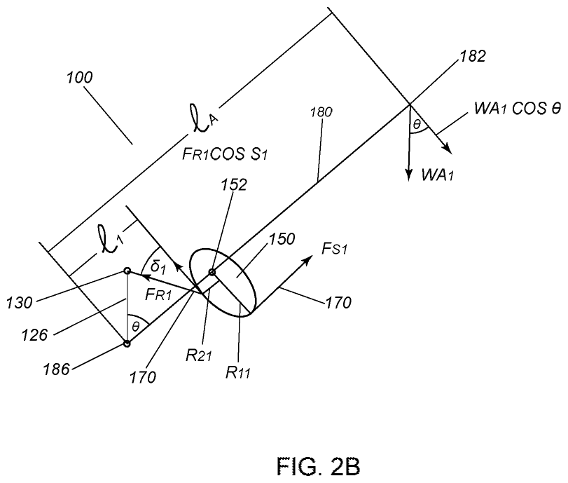

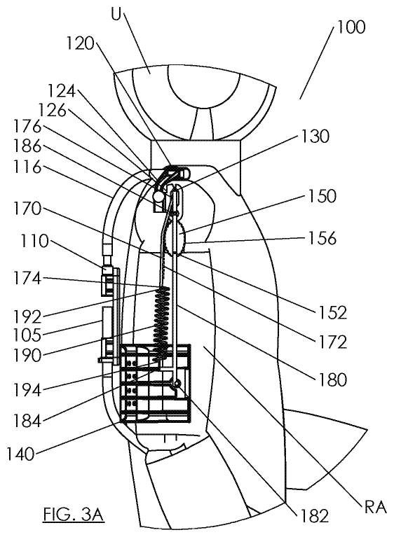

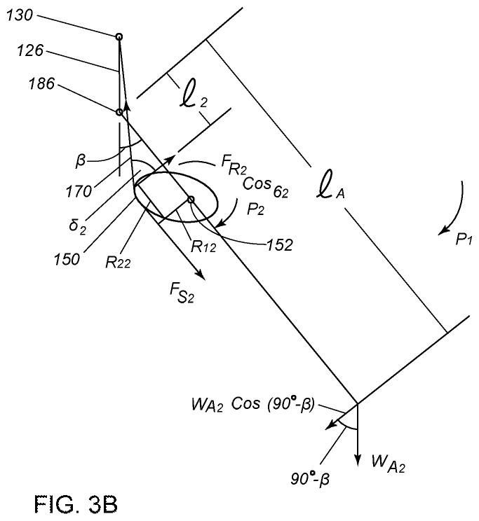

With additional reference to FIGS. 2A and 3A, the arm support includes a shoulder-arm bracket 124 and an arm bracket 180 that pivot about one or more axes relative to the frame 105. In addition, the arm support includes an armrest 140 mounted to the arm bracket 180 for receiving the user's upper arm, which may include one or more pads, covers, and/or straps (not shown) to secure the user's arm and/or increase comfort during use of the arm support.

As shown, the shoulder-arm bracket 124 is coupled to the shoulder tube 116 at the vertical axis pivot 120 such that the shoulder-art bracket 124 may pivot about the vertical axis pivot 120 in a substantially horizontal plane. A hub 126 is attached to the shoulder-arm bracket 124 that provides a substantially horizontal pivot 186 about which the arm bracket 180 may pivot in a substantially vertical plane, i.e., rotate up and down as the user raises and lowers the upper arm. The hub 126 also provides an anchor location 130 for a first end of flexible band 170, which wraps partially around shaped pulley 150, and is connected to a resilient element 190, e.g., an extension spring, which is attached to the arm bracket 180.

The armrest 140 may be attached to the arm bracket 180 at pivot 182, e.g., such that the armrest 140 may rotate about a horizontal axis during movement of the user's arm. Optionally, the armrest 140 and arm bracket 180 may include a cooperating track and/or other features to allow adjustment of the distance between the armrest 140 and the hub 126, e.g., to accommodate different length upper arms.

FIG. 2A shows the arm support system 100 with the supported right arm RA raised and provides additional detail of an exemplary set of compensation elements, including a spring or other resilient element 190, a shaped pulley 150, and a flexible band 170, that provide an offset force to the arm bracket 180 and, consequently, the user's arm RA. A first end of the flexible band 170 is attached to the hub 126 at the anchor location 130 and a second end of the flexible band 170 is attached to a proximal or first end 192 of the resilient element 190 at anchor location 174 such that an intermediate portion of the flexible band 170 wraps partially around the shaped pulley 150.

The flexible band 170 may be flexible laterally but stiff or inelastic axially to accommodate wrapping around the shaped pulley 150 while transmitting tensile forces from the resilient element. In exemplary embodiments, the flexible band 170 may be a flat strap or belt having a width similar to the shaped pulley 150, a cable, a chain, and the like, and, optionally, may include slip prevention features 172, such as teeth, rollers, beads, and the like.

The shaped pulley 150 is pivotally attached to the arm bracket 180 at pivot 152, and may be asymmetric, symmetric, round, or have other shapes. For example, the shaped pulley 150 may have an elliptical shape as shown with the pivot 152 offset from the center of the ellipse, or, alternatively, may have a circular shape with an offset pivot, and/or may have a central pivot (not shown). In another alternative, the shaped pulley 150 have a convex curved surface along only a portion of the perimeter of the shaped pulley 150, e.g., the portion contacted by the flexible band 170. Optionally, the shaped pulley 150 may include slip prevention features 156 such as teeth, rollers, beads, and the like that cooperate with similar features on the flexible band 170. Such slip prevention features may serve to maintain the positional relationship of the flexible band 170 and the shaped pulley 150, as described elsewhere herein.

The distal or second end 194 of the resilient element 190 is attached to the arm bracket 180 at attachment location 184 such that the second end 194 is fixed relative to the arm bracket 180 while the first end 192 is free to move, i.e., pulled or released as the flexible band 170 applies a tensile force to the first end 192.

During use, the hub 126 and first end of the flexible band 170 remain fixed relative to the arm bracket 180, while the shaped pulley 150 is free to rotate, thereby causing the intermediate portion of the flexible band 170 to move accordingly given their fixed positional relationship. For example, as the shaped pulley 150 rotates clockwise, the intermediate portion of the flexible band 170 also moves clockwise, thereby pulling on the second end of the flexible band 170 and, consequently, the resilient member 190, thereby increasing the potential force of the resilient member 190 acting on the flexible band 170. However, as described below, the shape of the shaped pulley 150 is configured to provide a mechanical disadvantage the potential force as the arm bracket 180 is lowered to reduce the resulting offset force applied to the arm bracket 180, and, conversely, provide a mechanical advantage as the arm bracket 180 is raised to increase the resulting offset force acting on the arm bracket 180.

For example, FIG. 2B is a schematic side view of the system 100 corresponding to the user's arm being raised, as shown in FIG. 2A. Arm weight Wa1 acting vertically has a cosine component Wa1 COS θ, which is a function of the angle of the arm bracket 180, acting perpendicular to the arm bracket 180. The arm weight Wa1 may be all, or part of, the effective weight of the user's arm RA in the position shown. In static balance, WA1 COS θ must be counterbalanced by the restoring force applied by the compensation elements of the system 100. The potential force provided by the resilient element 190, Fs1, which is a function of the characteristics of, and of the extension of, the resilient element 190, is applied to the shaped pulley 150 approximately at effective radius R11, thereby creating a “moment” on the shaped pulley 150.

When the user's arm is raised, as shown in FIG. 2A, the resilient element 190 is only slightly extended, so Fs1 is relatively low. To maintain the static balance of the shaped pulley 150 the moment generated by Fs1 is countered by the cosine component of the reaction force in the flexible band 170 Fr1, i.e., Fr1 COS δ1, which operates on radius R21 to provide a countering moment. Because R11 is greater than R21, Fr1 COS δ1 must be greater than Fs1, thus providing a mechanical advantage to the relatively low potential force applied by the resilient element 190 at this location, Fs1. Fr1 COS δ1 acts perpendicular to the arm bracket 180, at a distance l1 from the horizontal pivot 186, to create a counterbalancing moment to Wa1 COS θ acting at distance 1a from the horizontal pivot 186 and increase the resulting offset force, which supports the raised arm RA.

FIG. 3A is a side view of User U wearing arm the support system 100, with the right arm RA lowered and FIG. 3B is a schematic side view of the system 100 in FIG. 3A. As shown, the arm bracket 180 has rotated in response to the right arm RA being lowered, approximately along path P1. The shaped pulley 150 has rotated approximately along path P2. The potential force now provided by the resilient element 190, Fs2, is greater than the potential force Fs1 in FIG. 2B due to increased extension of the resilient element 190. The shaped pulley 150, having rotated approximately along path P1, now presents different radii to the forces acting on it. Fs2 acts on radius R12, while the perpendicular component of the new reaction force in the flexible band 170 Fr2 COS δ2 acts on radius R22.

As in other embodiments, Fs2 acts at an increasingly steep angle to the arm bracket 180, reducing the cosine component (the perpendicular component), and thus its ability to apply a moment to the arm bracket 180. Because R12 is less than R11, and R22 is greater than R21, Fr2 COS δ2 has increased mechanical advantage over Fs2 (which is greater than Fs1) compared to the advantage that Fr1 COS δ1 (FIG. 2B) had over Fs1. In addition, Fr2 COS δ2 acts a distance l2 from the horizontal pivot 186, which is less than 11 (FIG. 2B). Thus, a greater force in the resilient element 190 is “disadvantaged” (and thus modified) by the changing geometry of the system 100, e.g., to reduce the resulting offset force supporting the user's arm RA.

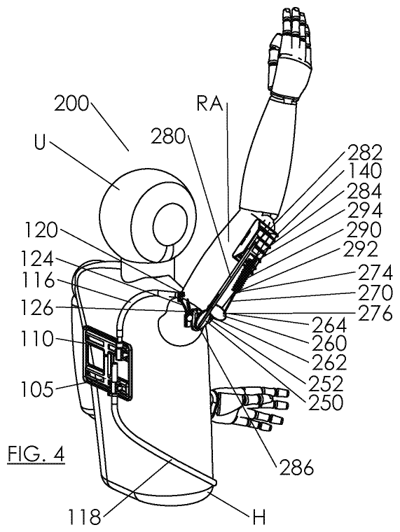

Turning to FIGS. 4-6B, another exemplary embodiment of an arm support system 200 is shown being worn by a user U. Generally, as best seen in FIG. 4, the system 200 includes a harness, e.g., including a frame 105, belt, and/or other components (not shown), and an arm support including a shoulder-arm bracket 124, arm bracket 280, and one or compensation elements, which provides a counterbalancing force to the user's right arm RA, similar to the previous embodiments described herein or in the applications incorporated by reference herein. The frame 105 provides a structure to transmit the weight of the arm RA to the user's abdomen A and/or hip H, and includes a back structure 110, one or more shoulder tubes or supports 116, and one or more abdomen tubes or supports 118, as described for the previously disclosed embodiments. As shown, the shoulder tubes 116 (only the right one shown) terminate adjacent or above the user's shoulder at vertical axis pivot 120.

The shoulder-arm bracket 124 is coupled to the shoulder tube 116 such that the shoulder-arm bracket 124 may pivot about vertical axis pivot 120 in a substantially horizontal plane. A hub 126 is attached to the shoulder-arm bracket 124 and includes provides a substantially horizontal pivot 286 about which the arm bracket 280 may pivot in a substantially vertical plane, e.g., as the user raises and lowers the upper arm. An armrest 140 is attached to the arm bracket 280, e.g., at pivot 282, also similar to the other embodiments herein.

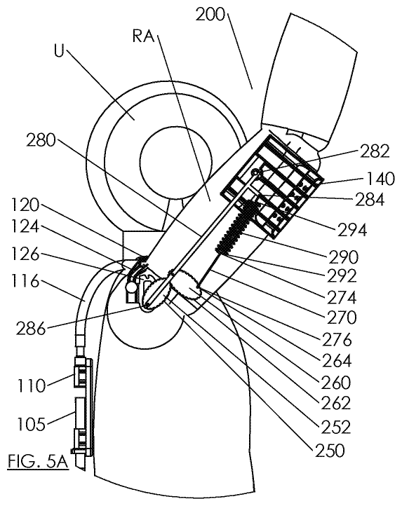

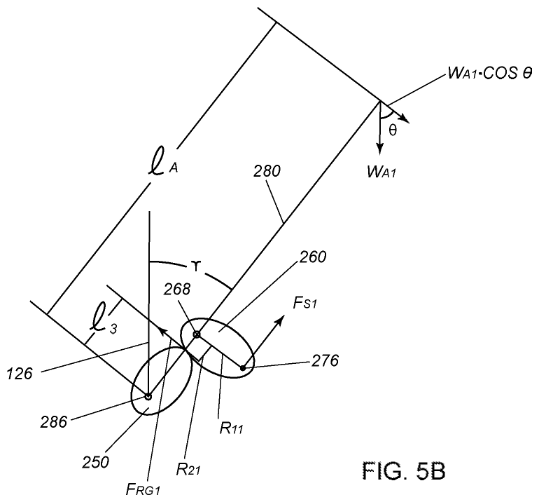

FIGS. 5A and 5B show the arm support system 200 with the supported right arm RA raised and lowered, respectively, and provide additional details of an exemplary set of compensation elements, including a spring or other resilient element 290, a stationary shaped gear or pulley 250, pivoting shaped gear or pulley 250, and a band 270, that provide an offset force to the arm bracket 280 and, consequently, the user's arm RA, similar to other embodiments herein.

As shown, the stationary gear 250 is fixed to the hub 126, shoulder-arm bracket 124, or other suitable structure, e.g., such that the stationary gear 250 does not move when the arm bracket 280 follows the user raising and lowering the arm RA. The pivoting gear 260 is pivotally attached to the arm bracket 280 at pivot 286, and disposed to mesh with the stationary gear 250 such that the pivoting gear 260 rotates and translates relative to the stationary gear 250. For example, the stationary gear 250 and the pivoting gear 260 may include a plurality of teeth, pins, bosses, cleats, or other engagement elements 252, 262 that cooperate to maintain their positional relationship, e.g., to allow the pivoting gear 260 to rotate and travel circumferentially around a portion of the stationary gear 250 without slipping.

In addition or alternatively, the stationary gear 250 and pivoting gear 260 may be spur gears, other types of gears, sprockets, which may be asymmetric or symmetric. For example, the stationary gear 250 may define an elliptical convex contact surface along which the pivoting gear 260 may move. The pivoting gear 260 may have an elliptical shape as shown with the pivot 268 offset from the center of the ellipse, or, alternatively, may have a circular shape with an offset pivot, and/or may have a central pivot (not shown). In another alternative, the stationary and pivoting gears 250, 260 may have convex curved surfaces along only a portion of their outer surfaces, e.g., where they contact one another, to provide a curved path along which the pivoting gear 260 may travel (rotate and translate).

The resilient element 290 is coupled to the pivoting gear 260, via the band 270, e.g., with a first end of the band 270 attached to the pivoting gear 260 at location 264, and a second end of the band 270 attached to a first end of the resilient member 290. A second end of the resilient element 290 is attached to the arm bracket 280 at location 284 such that the second end is fixed relative to the arm bracket 280 while the first end is free to move, i.e., be pulled or released as the band 270 applies a tensile force to the first end of the resilient member 290.

During use, the stationary gear 250 remains fixed relative to the arm bracket 280, while the pivoting gear 260 is free to rotate and translate along a convex, curved contact surface of the stationary gear 250, thereby pulling on the first end of the band 270 and, consequently, the resilient member 290, thereby increasing the potential force of the resilient member 290 acting on the band 270. As described elsewhere herein, the shapes of the contact surfaces of the stationary gear 250 and the pivoting gear 260 are configured to provide a mechanical disadvantage to the potential force as the arm bracket 280 is lowered to reduce the resulting offset force applied to the arm bracket 280, and, conversely, provide a mechanical advantage as the arm bracket 280 is raised to increase the resulting offset force acting on the arm bracket 280.

For example, FIG. 5A shows the arm support system 200, with the right arm RA raised. The stationary gear 250 and pivoting gear 260, in the position shown, are meshed in an advantageous relationship for the relatively un-extended or low potential force resilient element 290. FIG. 5B is a schematic of the side view of the system 200 with the arm RA raised. Arm weight Wa1 acting vertically has a cosine component Wa1 COS θ, which is a function of the angle of the arm bracket 280, acting perpendicular to the arm bracket 280. Arm weight Wa1 may be all, or part of, the effective weight of the arm RA in the position shown.

In static balance, WA1 COS θ must be counterbalanced by the restoring force applied by the compensation elements of the system 200. The potential force provided by the resilient element 290, Fs1, which is a function of the characteristics of and extension of the resilient element 290, is applied to the pivoting gear 260 approximately at effective radius R11, thereby creating a “moment” on the pivoting gear 260. When the arm RA is raised, as shown in FIG. 5A, the resilient element 290 is only slightly extended, so Fs1 is relatively low.

To maintain the static balance of the pivoting gear 260, the moment generated by Fs1 is countered by the cosine component of the reaction force from the stationary gear 250 Frg1, which operates on radius R21 to provide a countering moment. Because R11 is greater than R21, Frg1 must be greater than Fs1, thus providing a mechanical advantage to the relatively low potential force applied by the resilient element 290 at this location, Fs1. Frg1, in the position shown, acts approximately perpendicular to the arm bracket 280, at a distance l3 from the horizontal pivot 286, to create a counterbalancing moment to Wa1 COS θ acting at distance 1a from horizontal pivot 286.

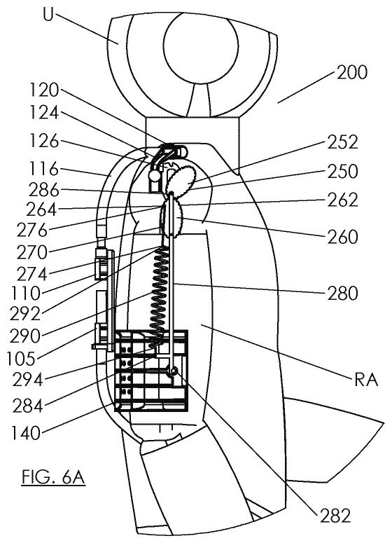

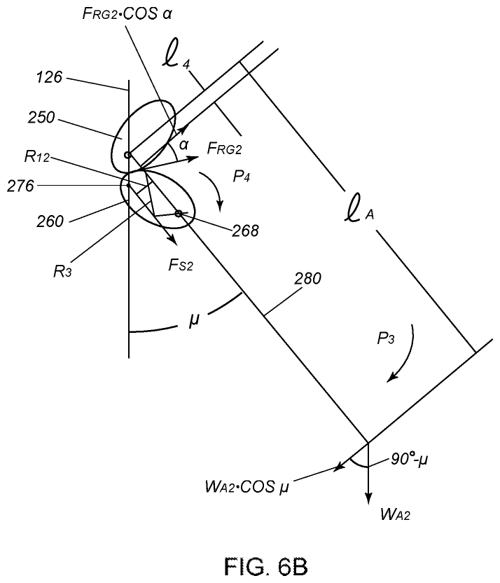

FIG. 6A shows the arm support system 200 with the right arm RA lowered and FIG. 6B is a schematic at this position. The arm bracket 280 has rotated in response to the arm RA being lowered, approximately along path P3. The pivoting gear 260 has rotated approximately along path P4 around the convex contact surface of the stationary gear 250. The shapes and dimensions of the stationary gear 250 and the pivoting gear 260, and their teeth 252, 262 (or other engagement features), are designed to continually maintain contact and the desired positional relationship. The potential force now provided by the resilient element 290, Fs2, is greater than the force Fs1 from FIG. 5B due to increased extension of the resilient element 290.

As indicated in FIG. 6B, the pivoting gear 260, having rotated approximately along path P4, now presents different radii to the forces acting on it. Fs2 acts on radius R12, while the new reaction force at stationary shaped gear 250, Frg2, acts on radius R3. Because R12 is less than R11, and R3 is greater than R21, Frg2 has increased mechanical advantage over Fs2 (which is greater than Fs1) compared to the advantage that Frg1 (FIG. 5B) had over Fs1. In addition, Frg2 COS α acts a distance l4 from the horizontal pivot 286, which is less than 13 (FIG. 5B). Thus, a greater potential force in the resilient element 290 is “disadvantaged” (and thus modified) by the changing geometry of the system 200.

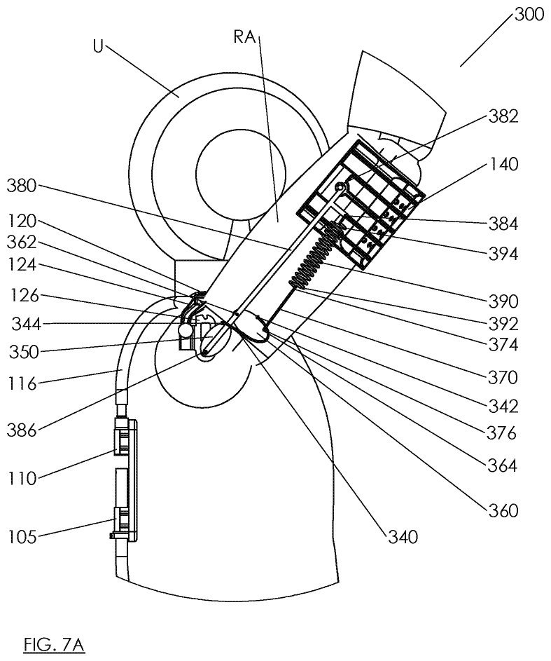

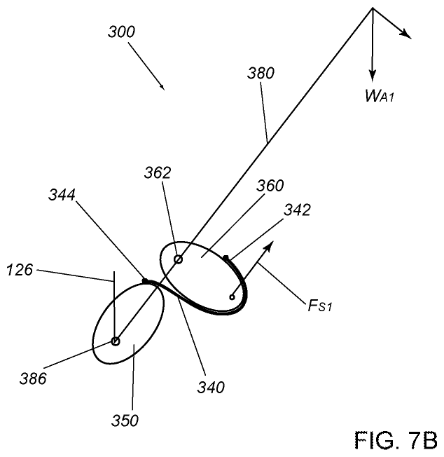

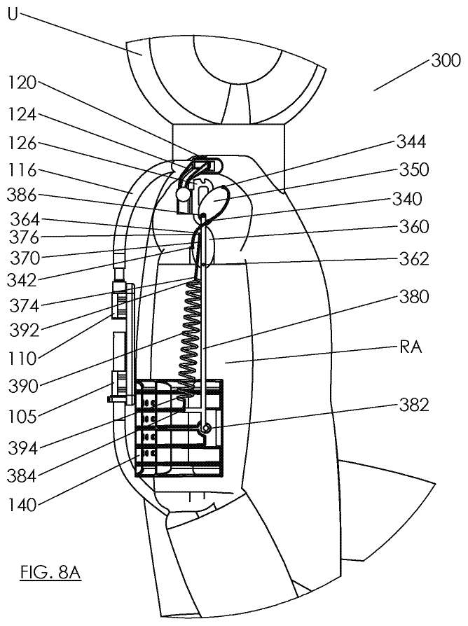

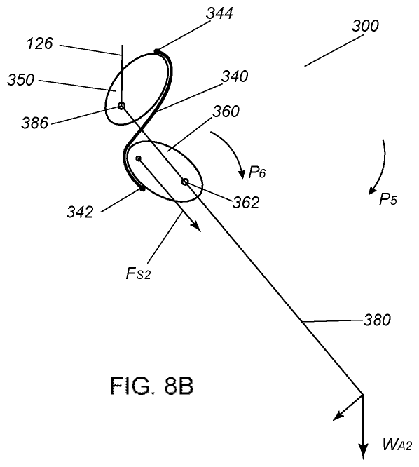

Turning to FIGS. 7A-8B, yet another embodiment of an arm support system 300 is shown being worn by a user U. Generally, the system 300 includes a harness, e.g., including a frame 105, belt, and/or other components (not shown), and an arm support including a shoulder-arm bracket 124, arm bracket 380, and one or compensation elements, which provides a counterbalancing force to the user's right arm RA, similar to the previous embodiments described herein or in the applications incorporated by reference herein. The frame 105 provides a structure to transmit the weight of the arm RA to the user's abdomen A and/or hip H, and includes a back structure 110, one or more shoulder tubes or supports 116, and one or more abdomen tubes or supports (not shown), as described for the previously disclosed embodiments. As shown, the shoulder tubes 116 (only the right one shown) terminate adjacent or above the user's shoulder at vertical axis pivot 120.

The shoulder-arm bracket 124 is coupled to the shoulder tube 116 such that the shoulder-arm bracket 124 pivots about vertical axis pivot 120 in a substantially horizontal plane. A hub 126 is attached to the shoulder-arm bracket 124 and includes a substantially horizontal pivot 386 about which the arm bracket 380 may pivot in a substantially vertical plane, e.g., as the user raises and lowers the upper arm. An armrest 140 is attached to the arm bracket 380, e.g., at pivot 382, also similar to the other embodiments herein.

FIGS. 7A and 8A show the arm support system 300 with the supported right arm RA raised and lowered, respectively, and provide additional details of an exemplary set of compensation elements, including a spring or other resilient element 390, a stationary pulley 350 and a pivoting pulley 360 joined by a flexible strap 340, and a band 370, that provide an offset force to the arm bracket 380 and, consequently, the user's arm RA, similar to other embodiments herein. In this embodiment, the stationary pulley 350 and pivoting pulley 360 include substantially smooth outer surfaces and are joined by strap 340 such that the pivoting pulley may pivot on its pivot 362.

Similar to previous embodiments, the stationary pulley 350 may be fixed to the hub 126, shoulder-arm bracket 124, or other suitable structure, e.g., such that the stationary pulley 350 does not move when the arm bracket 380 follows the user raising and lowering the arm RA. The pivoting pulley 360 is pivotally attached to the arm bracket 380 at pivot 386 such that the pivoting pulley 360 pivots on its pivot 362 and moves along a curved path relative to the stationary pulley 350 as the arm bracket 380 is raised and lowered. The strap 340 may be anchored to the stationary pulley 350 at anchor location 344, and to the pivoting pulley 360 at anchor location 342, and may wrap partially around the outer surface of both shaped pulleys 350, 360. In an exemplary embodiment, the strap 340 may be a strap or belt, or other laterally flexible but axially stiff element, e.g., an inelastic and/or nonextendable element, such as a chain or cable.

The resilient element 390 is coupled to the pivoting pulley 360, via the band 370, e.g., with a first end of the band 370 attached to the pivoting pulley 360 at location 364, and a second end of the band 370 attached to a first end of the resilient member 390. A second end of the resilient element 390 is attached to the arm bracket 380 at location 384 such that the second end is fixed relative to the arm bracket 380 while the first end is free to move, i.e., be pulled or released as the band 370 applies a tensile force to the first end of the resilient member 390.

During use, the stationary pulley 350 remains fixed relative to the arm bracket 380, while the pivoting pulley 360 is free to pivot on its pivot 362 in response to tension from the strap 340, thereby pulling on a first end of the band 370 and, consequently, the resilient member 390, thereby increasing the potential force of the resilient member 390 acting on the band 370. As described elsewhere herein, the shapes of the contact surfaces of the stationary gear 250 and the pivoting gear 260 are configured to provide a mechanical disadvantage to the potential force as the arm bracket 280 is lowered to reduce the resulting offset force applied to the arm bracket 280, and, conversely, provide a mechanical advantage as the arm bracket 280 is raised to increase the resulting offset force acting on the arm bracket 280.

For example, FIGS. 7A and 7B show the arm support system 300, with the right arm RA raised. Arm weight Wa1 acting vertically has a cosine component Wa1 COS θ, which is a function of the angle of the arm bracket 380, acting perpendicular to the arm bracket 380. Arm weight Wa1 may be all, or part of, the effective weight of the arm RA in the position shown.

In static balance, WA1 COS θ must be counterbalanced by the restoring force applied by the compensation elements of system 300. The potential force provided by the resilient element 390, Fs1 is applied to the pivoting pulley 360 approximately at effective radius, thereby creating a “moment” on the pivoting pulley 360. When the arm RA is raised, as shown in FIG. 7A, the resilient element 390 is only slightly extended, so Fs1 is relatively low. However, similar to the previous embodiments, the configuration of the pulleys 350, 360 provide a mechanical advantage to the relatively low potential force applied by the resilient element 390 and apply an offset force on the arm bracket 380 and, consequently, the arm RA.

FIGS. 8A and 8B show the system 300 with the user's arm RA lowered. The arm bracket 380 has rotated in response to the arm RA being lowered. As shown in FIG. 8b, the arm bracket 380 has rotated in response to the arm RA being lowered, approximately along path P5. The pivoting pulley 360 has rotated approximately along path P6, in response to tension from the strap 340, causing the strap 340 to wrap further around the outer surface of the stationary pulley 350 and partially unwrap from the pivoting pulley 360. The resilient element 390, further extended by the rotation of the pivoting pulley 360, applies an increased force Fs2. As in other embodiments, a greater force in the resilient element 390 (not shown, force represented by Fs2) is “disadvantaged” (and thus modified) by the changing geometry of the system 300.

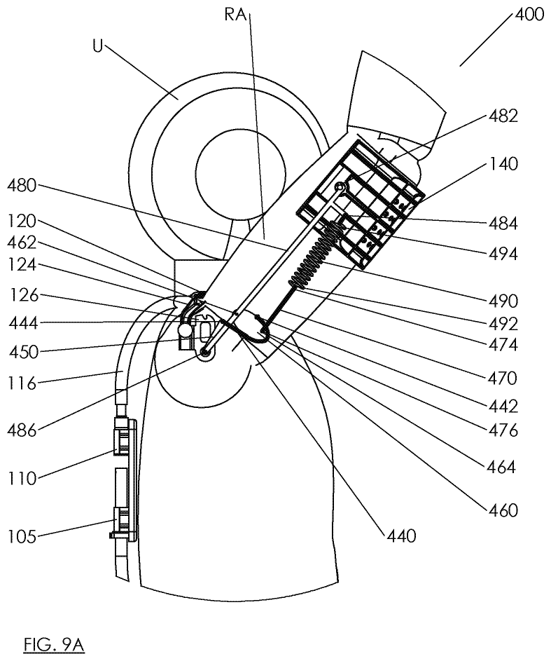

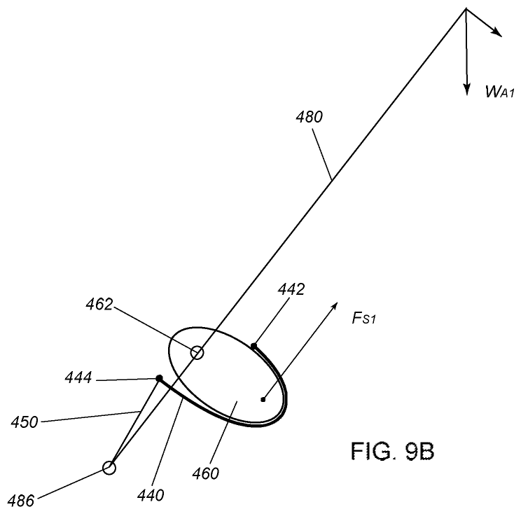

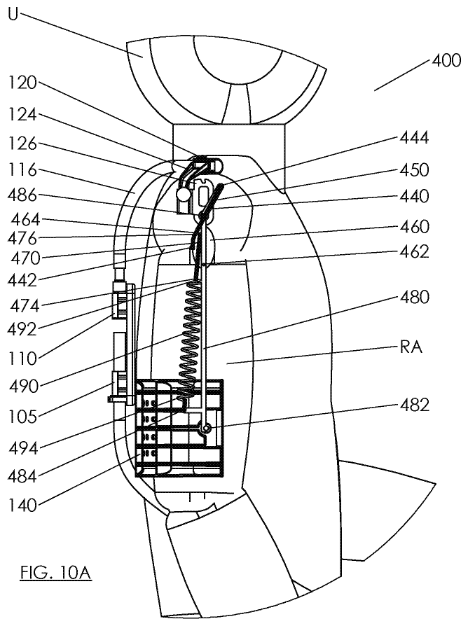

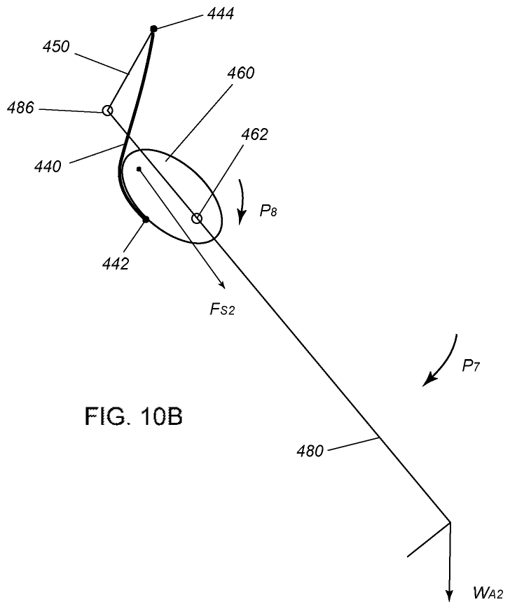

Turning to FIGS. 9A-10B, still another embodiment of an arm support system 400 is shown being worn by a user U. Generally, the system 400 includes a harness, e.g., including a frame 105, belt, and/or other components (not shown), and an arm support including a shoulder-arm bracket 124, arm bracket 480, and one or compensation elements, which provides a counterbalancing force to the user's right arm RA, similar to the previous embodiments described herein or in the applications incorporated by reference herein. The frame 105 provides a structure to transmit the weight of the arm RA to the user's abdomen A and/or hip H, and includes a back structure 110, one or more shoulder tubes or supports 116, and one or more abdomen tubes or supports (not shown), as described for the previously disclosed embodiments. As shown, the shoulder tubes 116 (only the right one shown) terminate adjacent or above the user's shoulder at vertical axis pivot 120.

The shoulder-arm bracket 124 is coupled to the shoulder tube 116 such that the shoulder-arm bracket 124 pivots about vertical axis pivot 120 in a substantially horizontal plane. A hub 126 is attached to the shoulder-arm bracket 124 and includes a substantially horizontal pivot 486 about which the arm bracket 480 may pivot in a substantially vertical plane, e.g., as the user raises and lowers the upper arm. An armrest 140 is attached to the arm bracket 480, e.g., at pivot 482, also similar to the other embodiments herein.

FIGS. 9A and 10A show the arm support system 300 with the supported right arm RA raised and lowered, respectively, and provide additional details of an exemplary set of compensation elements, including a spring or other resilient element 490, a stationary bar 450 (rather than a stationary pulley 350 as shown in FIGS. 7A-8B) and a pivoting pulley 460 joined by a flexible strap 440, and a band 470, that provide an offset force to the arm bracket 480 and, consequently, the user's arm RA, similar to other embodiments herein.

Similar to previous embodiments, the stationary bar 450 is fixed to the hub 126, shoulder-arm bracket 124, or other suitable structure, e.g., such that the stationary bar 450 does not move when the arm bracket 480 follows the user raising and lowering the arm RA. The pivoting pulley 460 is pivotally attached to the arm bracket 480 at pivot 486 such that the pivoting pulley 460 rotates and translates relative to the stationary bar 450. The strap 440 may be anchored to the stationary bar 40 at anchor location 444, and to the pivoting pulley 460 at anchor location 442, and may wrap partially around the outer surface of the pivoting pulley 460. In an exemplary embodiment, the strap 440 may be a strap or belt, or other laterally flexible but axially stiff element, e.g., an inelastic and/or nonextendable element, such as a chain or cable.

The resilient element 490 is coupled to the pivoting pulley 460, via the band 470, e.g., with a first end of the band 470 attached to the pivoting pulley 460 at location 464, and a second end of the band 470 attached to a first end of the resilient member 490. A second end of the resilient element 490 is attached to the arm bracket 480 at location 484 such that the second end is fixed relative to the arm bracket 480 while the first end is free to move, i.e., be pulled or released as the band 470 applies a tensile force to the first end of the resilient member 490.

Turning to FIG. 9B, the system 400 is shown with the user's arm RA raised. The potential force in the resilient element 490 is represented by Fs1, which has a mechanical advantage due to the shape and configuration of the pivoting pulley 460, similar to the previous embodiments.

FIGS. 10A and 10B shown the system 400 with the user's arm RA lowered. The arm bracket 480 has rotated in response to the arm RA being lowered and the pivoting pulley 460 has rotated about the pivot 462 in response to tension from the strap 440, causing the resilient element 490 to extend and increase its potential force. As best seen in FIG. 10B, the arm bracket 480 has rotated in response to the arm RA being lowered, approximately along path P7 and the pivoting pulley 460 has rotated approximately along path P8, in response to tension from the strap 440. The strap 440 has partially unwrapped from the pivoting shaped pulley 460. The resilient element 490, further extended by the rotation of the pivoting pulley 460, applies an increased potential force Fs2. As in other embodiments, a greater potential force in the resilient element 490 (represented by Fs2) is “disadvantaged” (and thus modified) by the changing geometry of the system 400.

It will be appreciated that elements or components shown with any embodiment herein are exemplary for the specific embodiment and may be used on or in combination with other embodiments disclosed herein.

While the invention is susceptible to various modifications, and alternative forms, specific examples thereof have been shown in the drawings and are herein described in detail. It should be understood, however, that the invention is not to be limited to the particular forms or methods disclosed, but to the contrary, the invention is to cover all modifications, equivalents and alternatives falling within the scope of the appended claims.

1. A system for supporting an arm of a user, comprising:
a harness configured to be worn on a body of a user;
an arm support coupled to the harness configured to support an arm of the user, the arm support comprising an arm bracket including an arm rest for receiving an upper arm of a user, the arm bracket pivotable about a horizontal axis for following movement of the upper arm as the upper arm is raised and lowered; and
one or more compensation elements coupled to the arm support to apply an offset force to the arm bracket to at least partially offset a gravitational force acting on the arm as the user raises and lowers the upper arm, the one or more compensation elements comprising:
a stationary member mounted on the arm support such that the stationary member remains stationary relative to the arm bracket as the arm bracket pivots about the horizontal axis;
a pivoting pulley mounted on the arm bracket such that the pivoting pulley rotates about a pivot point fixed relative to the arm bracket;
an elongate member comprising a first end coupled to the stationary member, a second end coupled to the pivoting pulley, and an intermediate portion wrapped partially around an outer surface of the pivoting pulley such that, as the arm bracket, pivots about the horizontal axis, the intermediate portion causes the pivoting pulley to rotate and further wrap and unwrap the intermediate region around the outer surface as the arm bracket is raised and lowered, respectively; and
a resilient member coupled to the pivoting pulley to apply a potential force to the pivoting pulley,
wherein the one or more compensation elements are configured such that a mechanical advantage is applied to the potential force as the upper arm is raised to increase the offset force applied to the arm bracket and a mechanical disadvantage is applied to the potential force as the upper arm is lowered to decrease the offset force applied to the arm bracket.

2. (canceled)

3. The system of claim 1, wherein the arm support comprises a shoulder bracket comprising a first end pivotally coupled to the harness at a vertical pivot such that the shoulder bracket pivots about the vertical pivot in a substantially horizontal plane, and a second end comprising a horizontal pivot point, the arm bracket coupled to the second end of the shoulder bracket such that the horizontal pivot point defines the horizontal axis.

4. The system of claim 3, wherein the harness comprises a frame including a shoulder support having a first end located above a shoulder of the arm being supported when the harness is worn by the user, and wherein the first end of the shoulder bracket is pivotally coupled to the first end of the shoulder support.

5. The system of claim 1, wherein the resilient element comprises a spring including a first end coupled to the pivoting pulley and a second end fixed to the arm bracket.

6. The system of claim 5, wherein the spring comprises an extension spring.

7. The system of claim 5, wherein the first end of the spring is coupled to the pivoting pulley by an elongate band.

8. The system of claim 1, wherein the pivoting pulley has an elliptical shape.

9. The system of claim 1, wherein the pivoting pulley has a circular shape and wherein the pivot point is offset from a center of the pivoting pulley.

10. The system of claim 1, wherein the pivoting pulley defines a convex curved outer surface around which the intermediate portion at least partially wraps.

11. The system of claim 1, wherein the stationary member comprises a stationary pulley and wherein a portion of the elongate member wraps partially around an outer surface of the stationary pulley as the arm bracket is lowered.

12. The system of claim 11, wherein the outer surface of the stationary member has a concave curved shape.

13. The system of claim 11, wherein the stationary pulley has an elliptical shape.

14. The system of claim 1, wherein the arm support comprises a shoulder bracket comprising a first end pivotally coupled to the harness at a vertical pivot such that the shoulder bracket pivots about the vertical pivot in a substantially horizontal plane, and a second end comprising a horizontal pivot point, the arm bracket coupled to the second end of the shoulder bracket such that the horizontal pivot point defines the horizontal axis, and
wherein the stationary member comprises a stationary bar including a first end fixedly mounted to the shoulder bracket and a second end, the first end of the elongate member coupled to the second end of the stationary bar.

15. (canceled)

16. A system for supporting an arm of a user, comprising:
a harness configured to be worn on a body of a user;
an arm support coupled to the harness configured to support an arm of the user, the arm support comprising an arm bracket configured to support an upper arm of a user, the arm bracket pivotable about a horizontal axis for following movement of the upper arm as the upper arm is raised and lowered; and
one or more compensation elements coupled to the arm support to apply an offset force to the arm bracket to at least partially offset a gravitational force acting on the arm as the user raises and lowers the upper arm, the one or more compensation elements comprising:
a pivoting pulley mounted on the arm bracket such that the pivoting pulley rotates about a pivot point on the arm bracket;
a resilient member comprising a resilient member first end fixed relative to the arm bracket and a resilient member second end;
an elongate band comprising a band first end fixedly coupled to the arm support, a band second end coupled to the resilient member second end, and an intermediate portion wrapped partially around an outer surface of the pivoting pulley such that, as the arm bracket pivots about the horizontal axis, the intermediate portion causes the pivoting pulley to rotate and applies tension to the resilient member to increase or decrease a potential force generated by the resilient member,
wherein the pivoting pulley and band are configured such that a mechanical advantage is applied to the potential force as the upper arm is raised to increase the offset force applied to the arm bracket and a mechanical disadvantage is applied to the potential force as the upper arm is lowered to decrease the offset force applied to the arm bracket.

17. The system of claim 16, wherein the outer surface of the pivoting pulley and the intermediate portion comprise cooperating engagement members that prevent the pivoting pulley from slipping relative to the band.

18. The system of claim 16, wherein the pivoting pulley has an elliptical shape.

19. The system of claim 16, wherein the pivoting pulley has a circular shape and wherein the pivot point is offset from a center of the pivoting pulley.

20. The system of claim 16, wherein the pivoting pulley defines a concave curved outer surface around which the intermediate portion at least partially wraps shaped to provide the mechanical advantage and mechanical disadvantage.

21-25. (canceled)

26. A method for supporting an arm of a user during one or more tasks, comprising:
placing a harness of an arm support system according to claim 1 on the user;
supporting an upper arm of the user using the arm support such that the arm support subsequently follows movement of the upper arm as the upper arm is raised and lowered; and
performing one or more tasks involving movement of the user's arm, the arm support comprising one or more compensation elements that apply an offset force to the arm support to at least partially offset a gravitational force acting on the arm as the user moves without substantially interfering in the movement, the one or more compensation elements providing a force profile that varies the offset force based on an orientation of the arm support.

27-28. (canceled)
